(19) United States
(12) Patent Application Publication
(10) Pub. No.: US 2012/0206144 A1
(43) Pub. Date: Aug. 16, 2012

(54) Method and Apparatus for Monitoring Cement Sheath Degradation Related to CO2 Exposure

(75) Inventor: Veronique Barlet-Gouedard, Chatenay Malabry (FR)

(73) Assignee: SCHLUMBERGER TECHNOLOGY CORPORATION, Sugar Land, TX (US)

(21) Appl. No.: 13/499,286

(22) PCT Filed: Oct. 8, 2010
(86) PCT No.: PCT/EP2010/006162

§ 371 Date: Apr. 23, 2012

(30) Foreign Application Priority Data
Oct. 12, 2009 (EP) 09290776.5

(51) Int. Cl. G01V 3/00

(52) U.S. Cl. 324/347

(57) ABSTRACT

The present invention provides methods, apparatuses and systems for more effectively and efficiently, directly and indirectly monitoring cement degradation related to carbon dioxide exposure by measuring one or more electrical properties related to resistivity of cement behind a casing in a well.

### BACKGROUND OF THE INVENTION

The present invention broadly relates to well cementing. More particularly the invention relates to a cement composition and related method of cementing for carbon dioxide environment, such as for instance a reservoir for storage of carbon dioxide gas.

In the construction of wells, cement is often used to secure and support casing inside the well and prevent fluid communication between the various underground fluid-containing layers or the production of unwanted fluids into the well. Long-term isolation and integrity of CO₂ injection wells clearly needs to be improved to ensure long-term environmental safety. Failure of the cement in the injection interval and above it may create preferential channels for carbon dioxide migration to the surface. This may occur on a much faster timescale than geological leakage. CO₂ injection well construction starts with drilling followed by well completion before starting CO₂ injection operations. In the framework of well completion, the cementation phase guarantees well isolation from the reservoir to the surface and isolation between geological formations. A crucial technical problem in well cementing operation or CO₂ sequestration is the chemical resistance of cement to CO₂ over time.

In addition, the environment of an underground reservoir might have high temperatures or pressures or have other hazards such as hydrogen sulfide, which might provide challenges to the material selection, well construction and/or placement process. Indeed, CO₂ combined with water can form carbonic acid, which could damage some conventional materials that might be used to transport, place or contain the CO₂, so material selection is important.

In the CO₂ sequestration, for example, one may want to prepare surface of the sequestration location in such a way that any leakage of CO₂ to the surface after placement is easily detectable and/or mitigated. It is desirable that the site be properly decommissioned after a preferably optimum amount of CO₂ is in place and the site monitored for sometime afterwards to ensure that the CO₂ placement is stable. It is desirable to ascertain the amount, location and state of the CO₂ during the placement process, after the CO₂ has been placed and for some period thereafter to ensure that the CO₂ stays where it has been placed and does not migrate to the surface or into drinking water aquifers. Post-decommissioning monitoring may be required by regulatory agencies.

Conventional Portland cement based systems, used during the well cementation phase, are known not to be thermodynamically unstable under CO₂ rich environments. This type of cement tends to degrade once exposed to such acid gases. Optimization of advanced systems allowing long-term well isolation is critical to allow safe and efficient underground activities. Indeed, any cracks or hole in the cement sheath might lead to safety problem such as “blow-out”.

But CO₂ environment present new challenges. While facing CO₂ underground, being for carbon sequestration application or well cementing for isolation, leakage behind the wall of an injection well casing may provide a pathway for CO₂ migration into unplanned zones (other formations, adjacent reservoir zones, and other areas) potentially leading to economic loss and/or safety problems. Such CO₂ leakage through the annulus may occur much more rapidly than geologic leakage through the formation rock. The possibility of such leaks raises considerable concern about the long-term wellbore isolation and the durability of hydrated cement that is used to isolate the annulus across the producing and injection intervals in CO₂-related wells.

The long-term CO₂ sequestration is a more recent concept but also requires long-term wellbore integrity. Indeed, the major risk associated by the public with CO₂ injection is a wellbore failure, which may result in escape of CO₂ that will migrate upwards; most cement being not thermodynamically stable under carbon dioxide environment.

The present invention provides methods, apparatuses and systems for more effectively and efficiently, directly and indirectly monitoring cement degradation related to carbon dioxide exposure by measuring one or more electrical properties related to resistivity of cement behind a casing in a well.

### SUMMARY OF THE INVENTION

The present invention also relates to the detection of any change in the cement sheath integrity in any well application. This might be, indeed, for oil-well, water storage, carbon sequestration or any gas containment.

The present invention relates to a method for measuring the integrity of the cement sheath involving resistivity measurement in situ. Such measurement would allow detecting any changes in the cement integrity especially when it reacts with CO₂.

An object of the present invention is to provide methods, apparatuses and systems for transporting, measuring, sequestering carbon, as well as site preparation and design, decommissioning a carbon sequestration site and providing post-decommissioning monitoring of the sequestration site, while eliminating or minimizing the impact of the problems and limitations described.

A further object of the invention concerns methods of sequestering CO2 comprising:
a. collecting carbon dioxide and preparing the carbon dioxide for sequestration;
b. selecting a storage site;
c. obtaining permits for using the storage site for sequestration;
d. preparing the storage site, including drilling at least one injection well having a casing cemented in place so that a cement sheath is in place between the final casing and a borehole wall of the well;
e. transporting the carbon dioxide to the storage site, measuring the carbon dioxide as desirable;
f. placing and monitoring CO₂, until sequestration is complete, including checking for problems and addressing the problems as needed, wherein the monitoring of CO₂ includes taking one or more measurements of an electrical property of the cement sheath related to resistivity of the cement sheath;
g. decommission sequestration site; and
h. monitoring the decommissioned site for leaks.

Other objects, features and advantages of the present invention will become apparent to those of skill in art by reference to the figures, the description that follows and the claims.

### BRIEF DESCRIPTION OF THE DRAWINGS

FIG. 1 is a flowchart for a generalized CO₂ sequestration process.

FIG. 2 is a flowchart for a CO₂ sequestration process, including an embodiment of the instant invention.

FIG. 3 is a simplified depiction of a well

FIG. 4 is a graph depicting evolution of Portland cement's resistivity with time in CO₂ fluids at 90° C. temperature and 280 bars pressure.

FIG. 5 is a graph plotting the imaginary part of conductivity of a Portland cement before and after CO₂ exposure, both to wet supercritical CO₂ and to CO₂ saturated water.

### DETAILED DESCRIPTION OF THE DRAWINGS

In the following detailed description of a preferred embodiment and other embodiments of the invention, reference is made to the accompanying drawings. It is to be understood that those of skill in the art will readily see other embodiments and changes may be made without departing from the scope of the invention.

Chemical reactions between cement and carbon dioxide occur as the following:
CO₂+H₂O⇄H₂CO₃⇄H⁺+HCO₃⁻⇄2H⁺+CO₃²⁻ which corresponds to the dissociation of carbon dioxide in water formation
the following reactions correspond to the reaction between cement and carbon dioxide as dissolution and carbonation

Ca(OH)₂(s)+2H⁺+CO₃²⁻→CaCO₃(s)+2H₂O (where 2H₂O is free water)

C_{3.4}—S₂—H₈(s)+2H⁺+CO₃²⁻→CaCO₃(s)+SiOₓOHₓ(s) (where SiOₓOHₓ(s) is silica gel)

Ca(OH)₂(s)+H⁺+HCO₃⁻→CaCO₃(s)+2H₂O

C_{3.4}—S₂—H₈(s)+H⁺+HCO₃⁻→CaCO₃(s)+SiOₓOHₓ(s)
Calcite dissolution under acidic condition

CO₂+H₂O+CaCO₃(s)⇄Ca²⁺+2HCO³⁻

2H⁺+CaCO₃(s)⇄CO₂+Ca²⁺+H₂O

Cement alteration may be characterized in laboratory by a complex series of concentric carbonation fronts after CO₂ attack. This chemical alteration is a very effective process with a significant pH decrease of interstitial fluid triggering possibly casing corrosion. An initial sealing by carbonation is followed by a dissolution stage, which starts earlier in CO₂-saturated water than in wet supercritical CO₂. After six months, the degradation is very high and shows a “spalling effect” (cement material starts to peel out). The evaluation of this alteration may be performed with different measurements on set cement samples as mechanical properties evolution but also as pH, porosity, permeability and resistivity before and after CO₂ exposure.

The cement alteration firstly controlled by the CO₂ diffusion through the cement matrix is followed by a mechanical alteration resulting from the carbonation and the dissolution of calcite, creating micro-cracks in the cement. The micro cracks could accelerate CO₂ leakage up to the surface as a preferential pathway for CO₂.

As the carbon sequestration is probably the conditions where the cement is likely to be in contact with long period and at high concentration, this will be used as a preferred embodiment in the following disclosure; however, the method according to the present invention is applicable to any cemented well in contact with CO₂.

The concept of CO₂ generation and sequestration are nowadays pretty well understood. Large-scale CO₂ sources, for example, ethanol plants, cement factories, steel factories, refineries, electricity generation plants, coal and biomass operations generate CO₂ and usually vent it as atmospheric CO₂. Some large scale CO₂ sources may transport the CO₂ to factories where the CO₂ can be used for industrial processes or for food and drink products. Some CO₂ is sequestered through natural processes such as from trees “inhaling” CO₂ and “exhaling” O₂ (oxygen). But CO₂ may be taken to a CO₂ capture facility, where the CO₂ is processed and then geologically sequestered. In geologic sequestration, the CO₂ is injected down one or more wells and into an appropriate formation, such as a coal seam where the CO₂ can displace methane to a production well by which the methane can be produced. Another appropriate formation might be a suitable depleted oil and/or gas reservoir. Another appropriate formation might be a suitable reservoir with trapped oil that the CO₂ may be used to displace to a production well by which the oil may be produced. Another appropriate formation might be a saline reservoir with a suitable trapping structure.

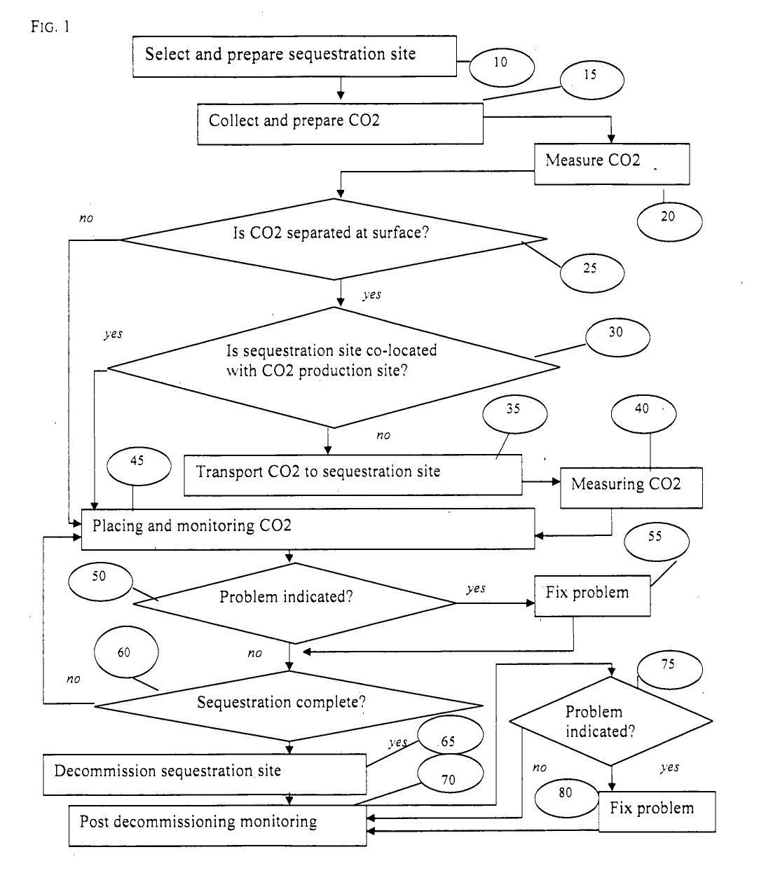

FIG. 1 is a depiction of an overview of a CO₂ sequestration process, which may be used with or without embodiments of the instant invention. One selects and prepares 12 a sequestration site. This may be a lengthy and involved process involving many steps and considerations. If the CO₂ is being produced with hydrocarbons, it can be separated underground and be sequestered without reaching the surface. If the CO₂ is being collected at the surface, a determination would be made as to whether there was a place to sequester the CO₂ onsite or whether the CO₂ might have to be transported to another site. If transportation is necessary, the possible sites available would be considered along with their relative advantages and disadvantages.

Referring again to FIG. 1, CO₂ is collected and prepared 15 for storage. How the CO₂ is collected and prepared depends in part on the source of the CO₂. The source of the CO₂ may be a power plant, refinery, factory or other industrial site or the source of the CO₂ may be from hydrocarbon production. There are countless sources of CO₂, including every human being and animal on the planet and most automobiles, but carbon sequestration is currently most practical where the CO₂ is produced in large amounts and can be easily collected. The source of the CO₂ helps to determine whether the CO₂ requires processing, such as removal of moisture or other contaminants before transportation and/or sequestration. The CO₂ may be measured 20 as and/or after the CO₂ is collected and/or processed.

Referring again to FIG. 1, the process may be different, depending on whether the CO₂ is separated at the surface 25 and whether the sequestration is co-located with the CO₂ production site 30. If the CO₂ is not separated at the surface but rather underground as it is produced, for example with hydrocarbons, it might be possible to have the CO₂ placed and monitored 45 underground. In the more typical case of collecting and separating the CO₂ at the surface, then a determination is made as to whether 30 the selected sequestration site is co-located with CO₂ production site. If the CO₂ is co-located with the sequestration site the CO₂ may still need to be transported a short distance and measured as part of being placed and monitored 45, but if the sequestration site is not co-located with the CO₂ production site substantial transportation system 35, such as through a pipeline system, may be necessary. Measurements 40 may have to be taken at several points to ascertain that there is no CO₂ leakage occurring or to determine a location of any CO₂ leakage or simply to determine the amount of CO₂ at various points in the process.

Continuing to refer to FIG. 1, at the sequestration site, the CO₂ is placed generally through injection wells and monitored 45. Buffering may be provided to store CO₂ in case the sequestration site has to be temporarily shut down. As monitored sequestration progresses, if problems are indicated 50, they are evaluated and ameliorated or if possible, completely fixed 55. Monitoring may be used to determine whether the sequestered CO₂ is stable or whether the sequestered CO₂ is becoming permanently affixed in the storage formation. Sequestration continues until complete 60. Completion might occur for example, if the source of the CO₂ permanently shuts down or if the storage formation cannot accept any more CO₂. The sequestration site would then be properly decommissioned 65 and post-decommissioning monitoring 70 might begin. If the post-decommissioning monitoring detects 75 a problem, the problem situation may have to be improved or fixed 80.

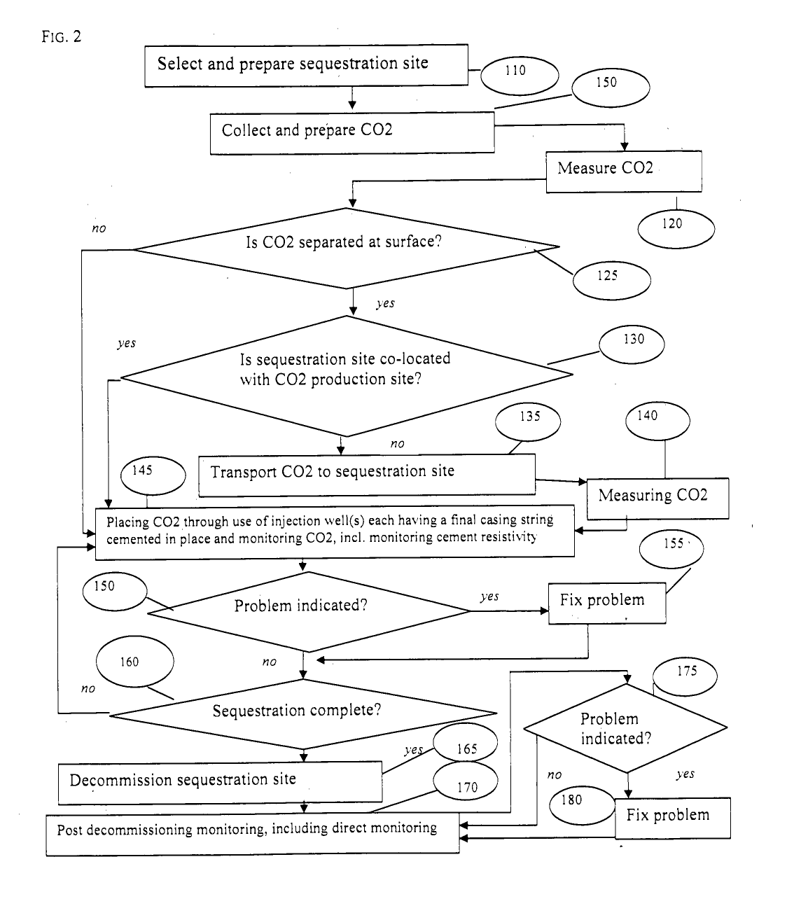

FIG. 2 is a flowchart for a CO₂ sequestration process, including an embodiment of the instant invention. As with the general process presented in FIG. 1, one selects and prepares 110 a sequestration site. This may be a lengthy and involved process involving many steps and considerations. If the CO₂ is being produced with hydrocarbons, the CO₂ might be separated underground and be sequestered without reaching the surface. If the CO₂ is being collected at the surface, a determination would be made as to whether there was a place to sequester the CO₂ onsite or whether the CO₂ might have to be transported to another site. If transportation is necessary, the possible sites available would be considered along with their relative advantages and disadvantages.

Referring again to FIG. 2, CO₂ is collected and prepared 115 for storage. How the CO₂ is collected and prepared depends in part on the source of the CO₂. The source of the CO₂ may be a power plant, refinery, factory or other industrial site or the source of the CO₂ may be from hydrocarbon production. The source of the CO₂ helps to determine whether the CO₂ requires processing, such as removal of moisture or other contaminants before transportation and/or sequestration. The CO₂ may be measured 120 as and/or after the CO₂ is collected and/or processed.

Referring again to FIG. 2, the process may be different, depending on whether the CO₂ is separated at the surface 125 and whether the sequestration is co-located with the CO₂ production site 130. If the CO₂ is not separated at the surface but rather underground as it is produced, for example with hydrocarbons, it might be possible to have the CO₂ placed and monitored 145 underground. In the more typical case of collecting and separating the CO₂ at the surface, then a determination is made as to whether 130 the selected sequestration site is co-located with CO₂ production site. If the CO₂ is co-located with the sequestration site the CO₂ may still need to be transported a short distance and measured as part of being placed and monitored 145, but if the sequestration site is not co-located with the CO₂ production site substantial transportation system 135, such as through a pipeline system, may be necessary. Measurements 140 may have to be taken at several points to ascertain that there is no CO₂ leakage occurring or to determine a location of any CO₂ leakage or simply to determine the amount of CO₂ at various points in the process.

Continuing to refer to FIG. 2, at the sequestration site, the CO₂ is placed through one or more injection wells and monitored 145. The injection wells have a final string of casing which has been cemented into place. In accordance with an embodiment of the present invention, the monitoring process includes measurement of one or more electrical properties related to resistivity of the cement used for the final string of casing. The measurement of the one or more electrical properties related to resistivity may be performed one different ways, some of which are further discussed herein. Buffering may be provided to store CO₂ in case the sequestration site has to be temporarily shut down. As monitored sequestration progresses, if problems are indicated 150, they are evaluated and ameliorated or if possible, completely fixed 155. Monitoring may be used to determine whether the sequestered CO₂ is stable or whether the sequestered CO₂ is becoming permanently affixed in the storage formation. Sequestration continues until complete 160. Completion might occur for example, if the source of the CO₂ permanently shuts down or if the storage formation cannot accept any more CO₂. The sequestration site would then be properly decommissioned 65 and post-decommissioning monitoring 170 might begin. If the post-decommissioning monitoring detects 175 a problem, the problem situation may have to be improved or fixed 180.

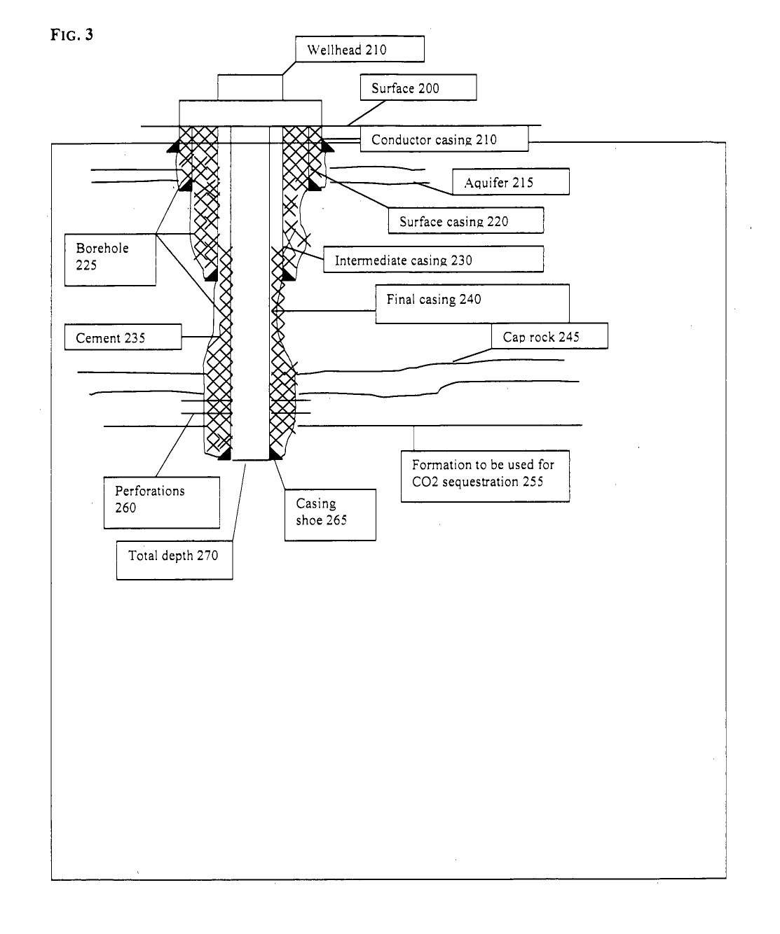

In an embodiment of the present invention, the injection well is drilled using conventional methods. FIG. 3 is a simplified depiction of a well (not to scale). The well is begun by having conductor casing 210 placed in the ground. Sometimes the well is drilled to the depth selected for conductor casing 210 and sometimes conductor casing 210 is pounded into the ground. Conductor casing 210 is placed to provide support for the injection well and is often placed at shallow depths, such as 18 to 35 meters or so. Using a bit smaller than the conductor casing 210, drilling of the well continues, usually through aquifers 215 until a predetermined depth for surface casing 220 is reached. The hole that is created while the well is being drilled is called the borehole 225. Surface casing 220 is set and cemented 235 into place, with the cement being pumped down the inside of the casing, through a casing shoe 265 on the bottom of the surface casing and then filling in the space (“annulus”) between the borehole 225 and outside surface of the surface casing 220 wall. Generally, for the surface casing, sufficient cement is used to bring the cement all the way back to the surface 200. The surface casing is designed to provide support for further drilling of the injection well and to protect for example the aquifers 215, preferably all aquifers 215 the injection well would traverse.

Continuing to refer to FIG. 3, using a bit smaller than the inside diameter of the surface casing, drilling of the well continues. Sometimes setting and cementing one or more intermediate casings 230 may be necessary, depending on the formations traversed by the injection well, their anticipated pressures and other hazards such as swelling clays and the total depth 270 of the injection well. If an intermediate casing is set, the bits used to drill below the intermediate casing are smaller than the internal diameter of the intermediate casing. In this case, the well is drilled through a cap rock 245, which forms a barrier to CO₂ migration, and through a formation to be used for CO₂ sequestration 255 to total depth 270.

At total depth 270, after evaluating the formations traversed by the injection well, a final casing 240 is set and cemented into place. In FIG. 3, the total depth 270 is deeper than the formation to be used for sequestration 255, shown along with its cap rock 245. After the cement 235 is put into place and sets properly, the final casing 240 is perforated, so that perforations 260 provide access for CO₂ injection from the inside of the final casing of the injection well through the cement and into the formation to be used for CO₂ sequestration 255. Although a full string of final casing extending from the total depth of the well to the surface is depicted in FIG. 3, sometimes liners that extend from the total depth only up to a hanger set near the bottom of in the last string of intermediate casing may be used, as is well known in the art. Similarly, although one particular well configuration is depicted in FIG. 3, many other configurations are possible as is well known in the art, including but not limited to different types of directional wells, horizontal wells, multiple completions of various kinds.

As mentioned earlier, the present invention is applicable to all cementing operations downhole; a type of cement commonly used for cementing for example casings in place is Portland cement. As Portland cement is exposed to CO₂, the Portland cement generally becomes more porous and may allow the CO₂ to leak through the Portland cement and migrate to the surface. Another situation might be a carbonation identified below a cap rock; this would usually be an indication of the formation of a micro-annulus allowing CO₂circulation along the well. In the context of the present invention, by cap rock, it is to be understood an impermeable layer which is above the reservoir where CO₂ will be stored. In the petroleum industry, caprock is generally referred to as any not permeable formation that may trap oil, gas or water, preventing it from migrating to the surface. This caprock or trap can create a reservoir of oil, gas or water beneath it and is a primary target for the petroleum industry.

Measurements of the resistivity of the cement sheath in situ, according to the present invention, would allow detecting changes in cement integrity when it reacts with carbon dioxide. In fact, the variation of the real part of cement's conductivity (which is the inverse of resistivity) is indicating any changes in the cement sheath during it carbonation and/or dissolution process with CO₂. The cement resistivity measurement would allow an “early warning” of CO₂ leakage through the monitoring of the degradation of the cement behind casing during the life of a well but also after its abandonment.

Different methods for measuring the resistivity of the cement sheath below or above the cap rock, might be used by the one skilled in the art; examples are cased holed measurements (through the casing) or resistivity in cement involving instrumented casing or sensors outside casing.

The electrical resistivity of sound Portland cement is generally around 10-20 Ohm. m. The evolution of cement resistivity after its exposure to CO₂ fluids (e.g. wet supercritical CO₂ fluid or CO₂ dissolved in water or in brine) has been studied and basically it evolves and increases significantly with the carbonation rate depending to the CO₂ exposure duration. The inverse of cement resistivity being cement conductivity, it is thus possible to measure the ability of cement to conduct electricity. Mathematically speaking, conductivity calculations may include the square root of a negative number, which means conductivity may have a real part and an imaginary part. Analysis of the imaginary part of cement's conductivity shows that frequency dependency decreases in direct proportion along with cement's carbonation. This change is correlated to porosity evolution of cement when it reacts with carbon dioxide present or stored in the reservoir. In other words, one can tell whether cement is becoming damaged by the CO₂, if one can measure changes in the cements electrical properties, like resistivity and/or conductivity.

Porosity of a Portland cement after CO₂-attack at several durations (0 hour, 44 hours, 1, 3, 6 weeks and 6 months) in wet supercritical CO₂ and in CO₂ dissolved in water fluids have been determined through mercury intrusion porosimetry, at 90° C. under 280 bars. Results are reproducible, and the trend observed is similar to the one obtained by back-scattered electron imaging. In both fluids, it has been shown that, in a first period, which lasts about 3 weeks, the initial porosity (35%) of Portland cement decreases up to 9% in CO₂ dissolved in water and 17% in wet supercritical CO₂, before starting to increase after 6 weeks (14% and 20% respectively) . This is due to carbonation, followed by a dissolution process. The threshold diameter, which is correlated to the permeability, tends to show the same behaviour: an opening of the pore entrance. These porosity results confirm the same trend as that observed with other physical parameters such as weight, density, pH, compressive strength, chemical analysis, and/or microstructural characterisations, i.e. that Portland cement continuously evolves during the carbonation process. It is noteworthy that pH of interstitial water strongly decreases from 13 initially to 6 during the carbonation process. It has to be noted that Portland cement, being widely used in the oilfield industry, is predominantly cited in the present application but the present invention is also applicable to CO₂ resistant cement such as Evercrete™ available from Schlumberger.

The pH of water in equilibrium with Portland cement cores initially equals to 13. After CO₂ attack, core samples are stored in water and the pH is measured at equilibrium. After each CO₂ attack, the new equilibrium pH is around 7 up to 3 weeks and decreases again up to 6 after six weeks and 3 months of experiment. Such CO₂ attack-related decrease of pH has already been reported in the literature (Van Gerven et al., 2004a; 2004b). This decrease results from the reaction between CO₂ and calcium from the calcium silicate phases or portlandite coming from Portland cement hydration.

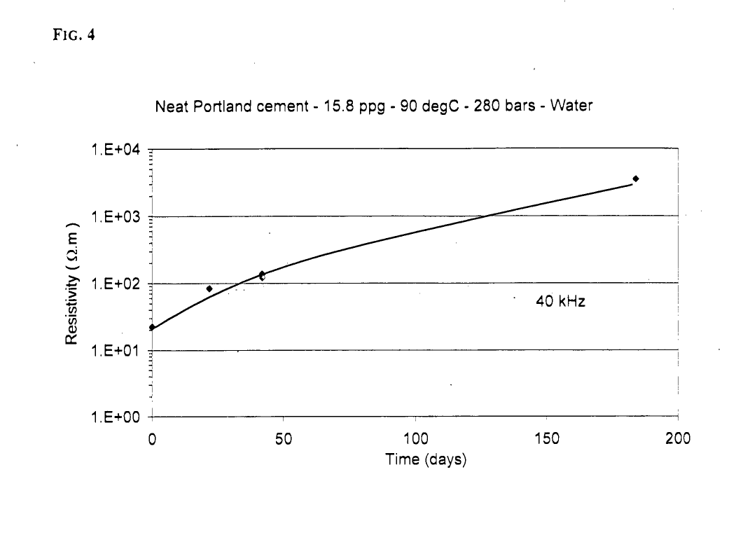

FIG. 4 is a graph depicting evolution of Portland cement's resistivity with time in CO₂ fluids at 90° C. temperature and 280 bars pressure. FIG. 4 indicates the resistivity of the cement exposed to CO₂ increasing over time, from about 20 ohm-meters at the beginning of the experiment to about 100 ohm-meters after about 3 weeks and to about 1000 ohm-meters after more than 150 days, in the experiment. In a Portland cement, as for any porous medium, the porosity variation and the composition of the interstitial water inside this porosity will affect its resistivity. The measurements of electrical resistivity of the cements included the use of the Impedance Phase/Gain Analyser SOLARTRON™ 1260 which have been used in the frequency band from 0.1 Hz to 0.3 MHz. As for conventional method of electrical impedance measurement, a 2-electrodes scheme was implemented to provide a homogeneous electric field in cement samples to be tested. Before measurements, each device had been calibrated to the open and closed electrical circuits, the resistance and capacitance of the measuring cell had been automatically compensated from the measured values. The electrical resistivity had been obtained from electrical impedance measurements Re[Zp] and Im[Zp] and samples' geometrical factor. A Portland cement with 35% porosity has a low resistivity around 20 Ohms. m [measured at a frequency of 40 kHz]. As the porosity decreases with a factor of 4 after 3 weeks (21 days) in CO₂ dissolved in water, a high variation of resistivity occurs (FIG. 4): the resistivity increases from 20 Ohms. m to 100 Ohms. m after 3 weeks and to 1000 Ohms. m after 6 months (168 days). In other words, as cement started to react with CO₂, the ability of the cement to conduct electricity is also damaged, with resistivity increasing and conductivity decreasing. Thus a cement resistivity measurement or conductivity measurement provides a method of “early warning” for the monitoring of CO₂ leaks through the monitoring of the degradation of the cement behind casing (sometimes called a cement sheath) during the life of the well but also after its abandonment. By monitoring the resistivity of cement sheath during the life of the well and even after its abandonment, cement degradation under carbon dioxide may be tracked over with time, yielding a good indication of the level of the carbonation.

A method to calculate the resistivity of the cement according to the present invention is described below:
Impedance spectroscopy (IS) is a relatively new and powerful method of characterizing many of the electrical properties of materials and their interfaces using electronically conducting electrodes. The impedance is a complex number that can be written as follows:

Z(ω)=Z′+j Z″

with Z′ being the real part of Z(ω), Re(Z) and Z″ the imaginary part of Z(ω), Im(Z). The modulus of the impedance equals:

|Z(ω)|=[(Z′)²+(Z″)²]^{1/2}

The conductivity spectrum can be obtained from impedance spectrum by using the following equation:

$$σ ( ω ) = \frac{l}{{A}_{e} \times \vert Z ( ω ) \vert}$$

with σ being the conductivity (S/m), ω the frequency (Hz), |Z(ω)| the absolute value of impedance, l the spacing between electrodes (meters) and Aₑ the electrode crossectional area (in meters squared, m²).

As conductivity is the inverse of resistivity, at each frequency ω, the resistivity in Ohm-meters is calculated from the conductivity spectrum. Moreover, the complex dielectric constant s is also derived from impedance spectrum measurements, with the following equation:

$$ɛ = \frac{1}{i ω Z ( ω ) {ɛ}_{0} {A}_{e} l}$$

with ε₀ being the permittivity of free space (=8,884·10⁻¹² F/m).

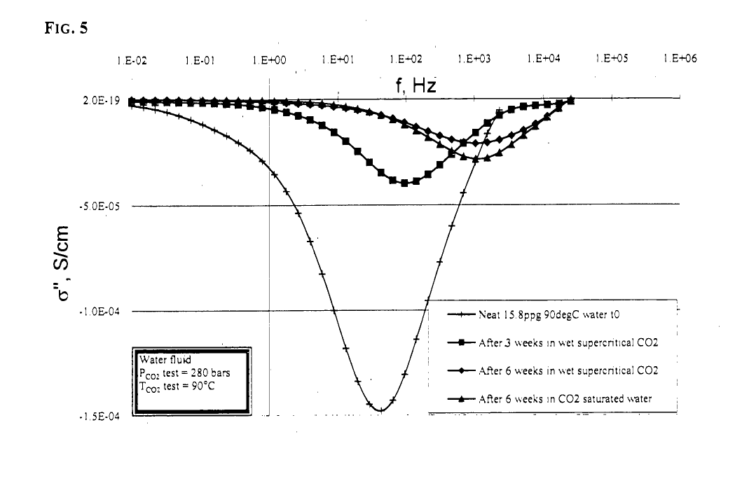

FIG. 5 is a graph plotting the imaginary part of conductivity of a Portland cement before and after CO₂ exposure, both to wet supercritical CO₂ and to CO₂ saturated water. FIG. 5 indicates a decrease in the imaginary part of the conductivity with increased times of CO₂ exposure. Moreover, the frequency dependence of the “imaginaire” part of conductivity (which is the inverse of resistivity) disappears after carbon dioxide exposure: this signal can be also used as an indicator of the cement reaction with carbon dioxide.

Different methods are available to measure electrical properties of the cement placed behind or inside the casing, below or above the caprock, in accordance with embodiments of the invention. The measurement may be of resistivity, conductivity or any other property of the cement from which resistivity or conductivity may be derived. The measurements may be made once or repeatedly over time, as a time lapse monitoring. Measurements may include, for example, cased-holed measurements (from the inside of the casing) which might be performed using cased-hole logging tools, or the measurements could be made using instrumented casing or sensors placed outside the casing. With the logging tools, a log may be produced and might evidence, for example cement resistivity of the cement sheath as a function of depth. While casing can interfere with resistivity measurements, resistivity of the cement sheath could be determined, behind the casing.

Sensors on the outside of the casing could be placed at one or at more than one different depths for measurements or placed in one or more configurations around the casing for measurements of the cement sheath in different directions. Useful set up can be found in U.S. Pat. No. 5,642,051, particularly FIG. 2A of that patent and the discussion of FIG. 2A therein. The sensors on the outside of the casing could have electrodes as described in U.S. Pat. No. 5,642,051 and instead of measuring properties of the fluids in a reservoir, could measure resistivity of the casing sheath. Signals could be sent from the sensors on the outside of the casing to the surface. When the measurements indicate cement degradation, methods to repair the cement or other proactive measures may be used to reduce or eliminate the chance of CO₂ migration towards the surface.

Although the foregoing is provided for purposes of illustrating, explaining and describing certain embodiments of the invention in particular detail, modifications and adaptations to the described methods, systems and other embodiments will be apparent to those skilled in the art and may be made without departing from the scope or spirit of the invention.

1. An apparatus for measuring an electrical property related to resistivity of a cement sheath behind a casing in a well comprising:
a. A sensor having at least one electrode installed on the outside of the casing so that the electrode is in contact with the cement, such that the electrode measures an electrical property of the cement related to resistivity of the cement; and
b. Communication means from the sensor to the surface.

2. The apparatus according to claim 1, further comprising a plurality of sensors having at least one electrode which are disposed on a support adapted to maintain a given spacing between the sensors and to isolate the sensors electrodes from one another.

3. The apparatus according to claim 2, wherein said support is formed by a rigid metal tube with an electrically insulating coating.

4. Apparatus according to claim 1, wherein said support is formed by an elongate member of non-rigid, electrically insulating material.

5. A method to evaluate the cement sheath integrity comprising measuring an electrical property of cement, preferably related to resistivity, and its evolution when said cement is exposed to CO₂.

6. The method of claim 5 wherein one of the one or more measurements of the electrical property of the cement sheath related to resistivity is electrical conductivity measurement.

7. The method of claim 5 wherein one of the one or more measurements of the electrical property of the cement sheath related to resistivity is an induction measurement.

8. The method of claim 5 wherein the measurement of the electrical property of the cement sheath related to resistivity is taken behind a casing.

9. The method of claim 8 wherein the measurement of the electrical property of the cement sheath related to resistivity is taken with one or more sensors installed on the outside of the casing.

10. The method of claim 8 wherein the casing cemented into place is a final casing in the well.

11. The method according to claim 5 wherein, the measurement allows the detection of cement sheath integrity failure in a well and then allows a selective cement remedial treatment comprising pumping remedial compounds at the location where the defect was identified.

12. The method of claim 11 wherein the well is an injection well for injecting CO₂ into a formation.

13. The method of claim 1 wherein the well is a monitoring well for monitoring the CO₂ sequestration process.

14. The method of claim 9 wherein the casing cemented into place is a final casing in the well.

15. A method for measuring an electrical property related to resistivity of a cement sheath behind a casing in a well comprising:
a. Installing a sensor having at least one electrode on the outside of the casing so that the sensor is in contact with the cement, such that the sensor measures an electrical property of the cement related to resistivity of the cement; and
b. Communication means from the sensor to the surface.

16. The method of claim 15, wherein the sensor is one or more electrodes.

17. The method of claim 15, comprising installing a plurality of sensors having at least one electrode which are disposed on a support adapted to maintain a given spacing between the sensors and to isolate the sensors electrodes from one another.

18. The method of claim 17, wherein the support is formed by a rigid metal tube with an electrically insulating coating.

19. The method of claim 17, wherein said support is formed by an elongate member of non-rigid, electrically insulating material.

20. The method of claim 15, wherein the well is a monitoring well for monitoring the CO₂ sequestration process.
